(19) United States
(12) Patent Application Publication
(10) Pub. No.: US 2023/0303829 A1
(43) Pub. Date: Sep. 28, 2023

(54) BIODEGRADABLE MATERIAL, PREPARATION METHOD AND APPLICATION THEREOF

(71) Applicant: Beijing Technology and Business University, Beijing (CN)

(72) Inventors: Yunxuan WENG, Beijing (CN); Xinyu SONG, Beijing (CN); Caili ZHANG, Beijing (CN); Xiaoqian DIAO, Beijing (CN)

(21) Appl. No.: 18/114,505

(22) Filed: Feb. 27, 2023

(30) Foreign Application Priority Data
Mar. 24, 2022 (CN) 202210295254.5

(51) Int. Cl. C08L 67/04; B29C 48/00; A47G 21/18; B29C 48/40; B29C 48/09

(52) U.S. Cl. CPC C08L 67/04; B29C 48/022; A47G 21/18; B29C 48/40; B29C 48/09; B29K 2067/04

(57) ABSTRACT

Disclosed are a biodegradable material and a preparation method and an application thereof, belong to the technical field of biodegradable materials. The preparation method includes mixing a certain amount of polyhydroxybutyrate-co-hydroxyvalerate copolymer (PHBV), polylactic acid (PLA), polybutylene adipate-terephthalate (PBAT) and epoxy chain extender or a certain amount of PHBV, PLA, polybutylene succinate (PBS) and epoxy chain extender, twin-screw extruding, cooling and cutting to obtain the biodegradable, green and environmentally friendly drinking straws.

### CROSS-REFERENCE TO RELATED APPLICATIONS

This application claims priority to Chinese Patent Application No. 202210295254.5, filed on Mar. 24, 2022, the contents of which are hereby incorporated by reference.

### TECHNICAL FIELD

The application belongs to the technical field of biodegradable materials, and in particular to a biodegradable material, a preparation method and an application thereof.

### BACKGROUND

The demand for drinking straws is increasing for convenient daily life. However, the short service time of drinking straws results in considerable consumption of plastics, and consequently great waste and environmental pollution. Therefore, varieties of drinking straws have been developed on the market to solve environmental problems. For example, paper straws are cheap and environmentally friendly, but they have strong water absorption, but their strength is decreased after water absorption. Metal straws are favored by the public because of their high mechanical strength and durability, but they are not easy to clean. Glass straws have various styles and are reusable, but they are expensive and fragile.

Biodegradable drinking straws made of biodegradable materials are popular in recent years because they are environmentally friendly and not fragile. At present, there is much research on biodegradable materials at home and abroad, and biodegradable materials have achieved rapid development, and some biodegradable products have been industrialized. However, there are still some problems in developing and applying biodegradable materials, such as the high cost of raw materials, which makes it difficult to popularize them, poor mechanical properties, water resistance, heat resistance and processability of the material. Therefore, it is necessary to develop new biodegradable materials with low costs, excellent mechanical properties, heat resistance and moisture resistance, and to prepare drinking straws with excellent mechanical properties, heat resistance and moisture resistance by using the new biodegradable materials.

### SUMMARY

Aiming at the shortcomings in the prior art, the application provides a biodegradable material, a preparation method and an application thereof.

In order to achieve the above objectives, the present application provides the following technical scheme.

According to one of technical schemes of the application, a biodegradable material includes following raw materials in parts by weight: 20-40 parts of polybutylene adipate-terephthalate, 50-60 parts of polyhydroxybutyrate-co-hydroxyvalerate copolymer and 10-20 parts of polylactic acid, and 1-2 parts of styrene-glycidyl methacrylate oligomer is also contained in every 100 parts of mixture of the polybutylene adipate-terephthalate, the polyhydroxybutyrate-co-hydroxyvalerate copolymer and the polylactic acid.

Optionally, the raw materials include in parts by weight 30 parts of the polybutylene adipate-terephthalate, 50 parts of the polyhydroxybutyrate-co-hydroxyvalerate copolymer, 20 parts of the polylactic acid and 1 part of the styrene-glycidyl methacrylate oligomer.

Optionally, raw materials include in parts by weight: 20-40 parts of polybutylene adipate-terephthalate, 50-60 parts of polyhydroxybutyrate-co-hydroxyvalerate copolymer and 10-20 parts of polylactic acid, and 1-2 parts of styrene-glycidyl methacrylate oligomer and 5-15 parts of bio-based epoxidation modifier are also contained in every 100 parts of mixture of the polybutylene adipate-terephthalate, the polyhydroxybutyrate-co-hydroxyvalerate copolymer and the polylactic acid. The bio-based epoxidation modifier includes epoxidized vegetable oil, epoxidized fatty acid ester or epoxidized cardanol ester; the epoxidized cardanol ester includes epoxidized cardanol glycidyl ether.

Optionally, the raw materials include in parts by weight 30 parts of the polybutylene adipate-terephthalate, 50 parts of the polyhydroxybutyrate-co-hydroxyvalerate copolymer, 20 parts of the polylactic acid, 1 part of the styrene-glycidyl methacrylate oligomer and 10 parts of the epoxidized cardanol glycidyl ether.

According to another technical scheme of the application, a biodegradable material includes following raw materials in parts by weight: 50-60 parts of polyhydroxybutyrate-co-hydroxyvalerate copolymer, 10-20 parts of polylactic acid and 20-40 parts of polybutylene succinate, and 1-2 parts of styrene-glycidyl methacrylate oligomer is also contained in every 100 parts of mixture of the polyhydroxybutyrate-co-hydroxyvalerate copolymer, the polylactic acid and the polybutylene succinate.

Optionally, the raw materials include in parts by weight 50 parts of the polyhydroxybutyrate-co-hydroxyvalerate copolymer, 20 parts of the polylactic acid, 30 parts of the polybutylene succinate and 1 part of styrene-glycidyl methacrylate oligomer.

Optionally, the raw materials include in parts by weight 50-60 parts of polyhydroxybutyrate-co-hydroxyvalerate copolymer, 10-20 parts of polylactic acid and 20-40 parts of polybutylene succinate, and 1-2 parts of styrene-glycidyl methacrylate oligomer and 5-15 parts of bio-based epoxidation modifier are also contained in every 100 parts of mixture of the polyhydroxybutyrate-co-hydroxyvalerate copolymer, the polylactic acid and the polybutylene succinate. The bio-based epoxidation modifier includes epoxidized vegetable oil, epoxidized fatty acid ester or epoxidized cardanol ester; the epoxidized cardanol ester includes epoxidized cardanol glycidyl ether.

Optionally, the raw materials include in parts by weight 50 parts of the polyhydroxybutyrate-co-hydroxyvalerate copolymer, 20 parts of the polylactic acid, 30 parts of the polybutylene succinate, 1 part of styrene-glycidyl methacrylate oligomer and 5 parts of the epoxidized cardanol glycidyl ether.

According to another technical scheme of the application, a preparation method of the biodegradable material includes following steps: mixing the raw materials, and twin-screw extruding to obtain the biodegradable material.

Optionally, temperature of the twin-screw extruding is 150-180° C.

Further Optionally, temperature of each section of the twin-screw extruding is set as follows: a first section-a fourth section: 155±5° C., a fifth section-a seventh section: 165±5° C., an eighth section-an eleventh section: 170±5° C., a twelfth section-a fourteenth section: 160±5° C., and a die: 155±3° C.

Optionally, a melt pressure of twin-screw extruding is less than 10 MPa (megapascal), a rotation speed of a main screw is 60-80 r/s (revolutions per second), and a feeding speed is 5-8 r/s.

Further Optionally, the melt pressure of the twin-screw extruding is 3 MPa, the rotation speed of the main screw is 60 r/s, and the feeding speed is 5 r/s.

According to another technical scheme of the application, an application of the biodegradable material in preparing drinking straws is provided.

According to another technical scheme of the application, biodegradable drinking straws are made of above biodegradable material.

Polybutylene adipate-terephthalate (PBAT) is a completely degradable thermoplastic polymer, which has good ductility and elongation at break, good film-forming property and water resistance, and has mechanical properties similar to those of polyethylene, so the PBAT has potential application prospects in packaging films, compost bags and agricultural films. Although the PBAT has excellent toughness, pure PBAT material has poor crystallinity and low strength, so PBAT is not suitable for preparing drinking straw products that require strength to some extent.

Polyhydroxybutyrate-co-hydroxyvalerate (PHBV) copolymer may be produced from renewable natural materials by bacterial fermentation and is a bio-based biodegradable material. The PHBV has good biocompatibility, biodegradability and bioabsorbability, but its crystallization speed is slow, its crystallinity is high, its brittleness is high, and its processing and molding are difficult. Blending the PBAT with the PHBV not only accelerates the degradation of the PBAT, but also improves the comprehensive properties of the PHBV. The polylactic acid (PLA) is a kind of thermoplastic degradable aliphatic polyester, which may be made from renewable resources. The PLA has high transparency, modulus and strength, and is comparable with many petroleum-based plastics. However, the PLA has high brittleness, low elongation at break, low impact strength, easy bending deflection and low toughness. In addition, the low melt strength of PLA at room temperature limits its application in large-scale processes, such as blown film extrusion, blow molding and foaming, so it is necessary to improve the melt strength to expand its processing window and application scope. In addition, the unmodified PLA drinking straws have poor heat resistance, and the drinking straws made from PLA is not suitable for hot drinks. However, polybutylene succinate (PBS), as an aliphatic polyester, has high heat resistance and may be used to prepare cold and hot drinking straws. However, stiffness and strength of PBS are low and storage stability of PBS is poor.

According to the application, the materials are subjected to composite modification in different proportions, so as to prepare the biodegradable drinking straws with high strength, good toughness and fast degradation speeds. In order to improve the compatibility of the blend system, the food-grade chain extender of Joncryl® ADR 4468 containing styrene-glycidyl methacrylate oligomer is selected for compatibilization, thus reducing the phase interface and improving the processing thermal stability of the composites.

Compared with the prior art, the application has the following beneficial effects.

According to the application, a certain amount of PHBV, PBAT, PLA and ADR or a certain amount of PHBV, PBS, PLA and ADR are used as raw materials, and the prepared material has excellent mechanical properties, processability, cold and hot resistance and water resistance, and is suitable for various cold and hot drinks; compared with the conventional drinking straws, the comprehensive property of the drinking straws prepared by the raw materials in the application is further improved and provides better product experience.

In the optional schemes of the application, by adding the bio-based epoxidation modifier into the raw materials, the mechanical properties of the obtained materials are further improved, and the water absorption rate is significantly reduced and the biodegradability is significantly improved.

According to the application, biodegradable polymers are used as raw materials, and the prepared materials are completely biodegradable and have the characteristics of environmental protection and non-toxicity; and the prepared biodegradable drinking straws may be disposed by composting, soil landfill and the like after being discarded, which is green and environmentally friendly, has positive significance for solving the environmental pollution problem of disposable drinking straws, and conforms to the concept of sustainable development of environmental protection.

### DETAILED DESCRIPTION OF THE EMBODIMENTS

A number of exemplary embodiments of the present application will now be described in detail, and this detailed description should not be considered as a limitation of the present application, but should be understood as a more detailed description of certain aspects, characteristics and embodiments of the present application. It should be understood that the terminology described in the present application is only for describing specific embodiments and is not used to limit the present application.

In addition, for the numerical range in the present application, it should be understood that each intermediate value between the upper limit and the lower limit of the range is also specifically disclosed. The intermediate value within any stated value or stated range and every smaller range between any other stated value or intermediate value within the stated range are also included in the present application. The upper and lower limits of these smaller ranges may be independently included or excluded from the range.

Unless otherwise specified, all technical and scientific terms used herein have the same meaning as commonly understood by one of ordinary skill in the art to which this application relates. Although the present application only describes the preferred methods and materials, any methods and materials similar or equivalent to those described herein may also be used in the practice or testing of the present application. All documents mentioned in this specification are incorporated by reference to disclose and describe methods and/or materials related to the documents. In case of conflict with any incorporated document, the contents of this specification shall prevail.

It is obvious to those skilled in the art that many improvements and changes may be made to the specific embodiments of the present application without departing from the scope or spirit of the present application. Other embodiments will be obvious to the skilled person from the description of the application. The description and example of that present application are exemplary only.

The terms “comprising”, “including”, “having” and “containing” used in this article are all open terms, which means including but not limited to.

The “parts” mentioned in the present application refer to parts by weight unless otherwise specified.

In the following embodiments, polyhydroxybutyrate-co-hydroxyvalerate (PHBV) copolymer is ENMATY1000P purchased from TianAn Biologic Materials Co., Ltd., polybutylene adipate-terephthalate (PBAT) is Ecoworld purchased from Jin Hui Zhao Long High Technology Co., Ltd., polybutylene succinate (PBS) is TH803 S purchased from Xinjiang Blue Ridge Tunhe Sci&Tech. Co., Ltd., polylactic acid (PLA) is 4032D purchased from NatureWorks and chain extender adopted is BASF ADR 4468. Epoxidized soybean oil-sebacic acid (ESO-SA) adopted is prepared by mixing epoxidized soybean oil and sebacic acid in a mass ratio of 9:1, and performing grafting reaction at 150° C. under catalysis of 4-dimethylaminopyridine (DMAP) for 12-18 min (minutes). Epoxidized cardanol glycidyl ether (ECGE) adopted is prepared by mixing cardanol and glycidyl ether in a mass ratio of 1:2.5, and performing substitution reaction at 60-90° C. for 6 h (hours) in nitrogen atmosphere and then performing oxidation reaction at 65° C. for 3 h in air atmosphere.

Above details are not repeated again in following description.

### Comparative Example 1

Biodegradable drinking straws are prepared from following raw materials in parts by weight: 50 parts of PHBV, 30 parts of PBAT and 20 parts of PLA.

A preparation method includes: weighing the above raw materials according to parts by weight, mixing, performing twin-screw melt extrusion, cooling to obtain a biodegradable material, and cutting to obtain drinking straws (the twin-screw head is modified into a drinking straw machine head, so that the extruded materials are directly cut into drinking straws). The temperature of each section of the twin-screw extruder is set as follows: a first section is 153° C., a second section is 153° C., a third section is 155° C., a fourth section is 155° C., a fifth section is 160° C., a sixth section is 165° C., a seventh section is 165° C., an eighth section is 170° C., a ninth section is 170° C., a tenth section is 175° C., an eleventh section is 170° C., a twelfth section is 165° C., a thirteenth section is 160° C., a fourteenth section is 160° C., and a die is 155° C. The melt pressure of an extrusion is 3 MPa, a rotation speed of the main screw is 60 r/s, and a feeding speed is 5 r/s.

### Embodiment 1

The biodegradable drinking straws are prepared from following raw materials in parts by weight: 50 parts of PHBV, 30 parts of PBAT, 20 parts of PLA and 1 part of ADR.

The preparation method includes: weighing the above raw materials according to parts by weight, mixing, performing twin-screw melt extruding, cooling to obtain a biodegradable material, and cutting to obtain drinking straws, where during the twin-screw melt extrusion, the temperature, melt pressure, rotation speed of the main screw and the feeding speed of each section of a twin-screw extruder are set as same the comparative example 1.

### Embodiment 2

The biodegradable drinking straws are prepared from following raw materials in parts by weight: 50 parts of PHBV, 30 parts of PBAT, 20 parts of PLA, 1 part of ADR and 10 parts of ESO-SA.

The preparation method is the same as that of the comparative example 1.

### Embodiment 3

The biodegradable drinking straws are prepared from following raw materials in parts by weight: 50 parts of PHBV, 30 parts of PBAT, 20 parts of PLA, 1 part of ADR and 10 parts of ECGE.

The preparation method is the same as that of the comparative example 1.

### Comparative Example 2

The biodegradable drinking straws are prepared from following raw materials in parts by weight: 50 parts of PHBV, 30 parts of PBS and 20 parts of PLA.

The preparation method is the same as that of the comparative example 1.

### Embodiment 4

The biodegradable drinking straws are prepared from following raw materials in parts by weight: 50 parts of PHBV, 30 parts of PBS, 20 parts of PLA and 1 part of ADR.

The preparation method is the same as that of the comparative example 1.

### Embodiment 5

The biodegradable drinking straws are prepared from following raw materials in parts by weight: 50 parts of PHBV, 30 parts of PBS, 20 parts of PLA, 1 part of ADR and 5 parts of ESO-SA.

The preparation method is the same as that of the comparative example 1.

### Embodiment 6

The biodegradable drinking straws are prepared from following raw materials in parts by weight: 50 parts of PHBV, 30 parts of PBS, 20 parts of PLA, 1 part of ADR and 5 parts of ECGE.

The preparation method is the same as that of the comparative example 1.

### Effect Verification

The properties of biodegradable materials prepared in the above embodiments 1-6 and comparative examples 1-2 are tested, and test results are shown in table 1. Among them, the tensile strength and elongation at break are tested according to GB/T1040.1-2018, the melt flow index is tested according to GB/T3682.1-2018, the deflection temperature is tested according to GB/T1634.2-2019, the water absorption rate is tested according to GB/T1034-2008, and the biodegradation percentage for 180 days is tested according to GB/T19277.1-2011.

TABLE 1

| | | | | Heat | Water | Relative |
|---|---|---|---|---|---|---|
| | Tensile | Elongation | Melt flow | deflection | absorption | biodegradation |
| | strength | at break | index | temperature | rate | rate for 180 days |
| Sample group | (MPa) | (%) | (g/10 min) | (° C.) | (%) | (%) |
| Comparative | 31.59 ± 1.26 | 13.24 ± 1.02 | 5.63 | 88.3 | 12.35 | 91.3 |
| example 1 | | | | | | |
| Embodiment 1 | 32.48 ± 2.62 | 18.78 ± 2.31 | 7.36 | 88.5 | 10.23 | 91.1 |
| Embodiment 2 | 29.95 ± 0.98 | 25.31 ± 4.29 | 9.60 | 93.5 | 6.87 | 94.6 |
| Embodiment 3 | 29.31 ± 2.71 | 28.58 ± 2.77 | 10.34 | 92.9 | 6.68 | 93.8 |
| Comparative | 33.87 ± 2.21 | 11.66 ± 1.59 | 8.01 | 81.1 | 11.02 | 90.2 |
| example 2 | | | | | | |
| Embodiment 4 | 33.02 ± 1.69 | 12.30 ± 1.22 | 10.99 | 80.3 | 10.68 | 89.8 |
| Embodiment 5 | 30.65 ± 0.82 | 18.31 ± 3.25 | 13.55 | 82.6 | 7.12 | 92.9 |
| Embodiment 6 | 31.26 ± 1.66 | 20.27 ± 2.46 | 13.21 | 84.4 | 6.82 | 93.2 |

As can be seen from table 1, the fully biodegradable drinking straws prepared by PHBV/PBAT/PLA or PHBV/PBS/PLA which are modified by adding the bio-based epoxidation modifier in the application have excellent mechanical properties, cold and heat resistance, water resistance and processability. Compared with the composite material without modifier, the mechanical properties of the drinking straws with 5-10 parts of the ECGE are more excellent and all meet the requirements of GB/T41010-2021 for the relative biodegradation rate of degradable plastics.

The raw materials used in the drinking straws prepared by the application are biodegradable, have the characteristics of environmental protection and non-toxicity, have positive significance for solving the environmental pollution problem of disposable drinking straws, and conform to the sustainable development concept of environmental protection.

The above is only a preferred embodiment of the present application, and the scope of protection of the present application is not limited to this. An equivalent replacement or change made by any person familiar with the technical field within the technical scope disclosed by the present application according to the technical scheme and inventive concept of the present application should be included in the scope of protection of the present application.

What is claimed is:

1. A biodegradable material, comprising raw materials in parts by weight: 20-40 parts of polybutylene adipate-terephthalate, 50-60 parts of polyhydroxybutyrate-co-hydroxyvalerate copolymer and 10-20 parts of polylactic acid, and 1-2 parts of styrene-glycidyl methacrylate oligomer and 10 parts of bio-based epoxidation modifier also contained in every 100 parts of mixture of the polybutylene adipate-terephthalate, the polyhydroxybutyrate-co-hydroxyvalerate copolymer and the polylactic acid, wherein the bio-based epoxidation modifier is ESO-SA or ECGE;
wherein a preparation method of the ESO-SA comprises: mixing epoxidized soybean oil and sebacic acid in a mass ratio of 9:1, and performing grafting reaction at 150° C. with the presence of a catalytic agent DMAP for 12-18 min; and
a preparation method of the ECGE comprises: mixing cardanol and glycidyl ether according to a mass ratio of 1:2.5, firstly performing substitution reaction at 60-90° C. in nitrogen atmosphere for 6 h, and then performing oxidation reaction at 65° C. in air atmosphere for 3 h.

2. The biodegradable material according to claim 1, wherein the raw materials comprise in parts by weight: 30 parts of the polybutylene adipate-terephthalate, 50 parts of the polyhydroxybutyrate-co-hydroxyvalerate copolymer and 20 parts of the polylactic acid.

3. A biodegradable material, comprising raw materials in parts by weight: 50-60 parts of polyhydroxybutyrate-co-hydroxyvalerate copolymer, 10-20 parts of polylactic acid and 20-40 parts of polybutylene succinate and 1-2 parts of styrene-glycidyl methacrylate oligomer and 5 parts of bio-based epoxidation modifier are also contained in every 100 parts of mixture of the polyhydroxybutyrate-co-hydroxyvalerate copolymer, the polylactic acid and the polybutylene succinate, wherein the bio-based epoxidation modifier is ESO-SA or ECGE;
wherein a preparation method of the ESO-SA comprises: mixing epoxidized soybean oil and sebacic acid in a mass ratio of 9:1, and performing a grafting reaction at 150° C. under catalysis of DMAP for 12-18 min;
a preparation method of the ECGE comprises: mixing cardanol and glycidyl ether according to a mass ratio of 1:2.5, firstly performing a substitution reaction at 60-90° C. in nitrogen atmosphere for 6 h, and then performing an oxidation reaction at 65° C. in air atmosphere for 3 h.

4. The biodegradable material according to claim 3, wherein the raw materials comprise in parts by weight: 50 parts of the polyhydroxybutyrate-co-hydroxyvalerate copolymer, 20 parts of the polylactic acid, 30 parts of the polybutylene succinate, and 1 part of the styrene-glycidyl methacrylate oligomer.

5. A preparation method of the biodegradable material according to claim 1, comprising following steps: mixing the raw materials, and twin-screw extruding to obtain the biodegradable material.

6. The preparation method according to claim 5, wherein a temperature of the twin-screw extruding is 150-180° C.

7. The preparation method according to claim 6, wherein temperatures of each section of the twin-screw extruding are: a first section-a fourth section: 155±5° C., a fifth section-a seventh section: 165±5° C., an eighth section-an eleventh section: 170±5° C., a twelfth section to a fourteenth section: 160±5° C., and a die: 155±3° C.

8. An application of the biodegradable material according to claim 1 in preparing drinking straws.

9. A biodegradable drinking straw, comprising the biodegradable material according to claim 1 as a raw material.
